(19) United States
(12) Patent Application Publication
(10) Pub. No.: US 2008/0178255 A1
(43) Pub. Date: Jul. 24, 2008

(54) Method for document oriented adaptive security management

(76) Inventor: Vladimir Y. Gaikovich, Moscow (RU)

Correspondence Address: Oppedahl Patent Law Firm LLC, P.O. BOX 4850, FRISCO, CO, 80443-4850, US

(21) Appl. No.: 11/692,976

(22) Filed: Mar. 29, 2007

(30) Foreign Application Priority Data
Dec. 15, 2006 (RU) 2006144646

(51) Int. Cl. H04L 9/00

(52) U.S. Cl. 726/1; 726/7

(57) ABSTRACT

A method of operating document flow within a security system uses a server, a data base, a subsystem that has a system configuration and a Web portal, and an agent module that controls the access to the system's secured information, an IT system, the IT system being connected with changes of official, project, duties, and IT-objects of IT system, each said IT-object having access to a resource type. The method includes: developing a request to change an access right of a subordinate employee by an enterprise employee by inputting information on the change of access rights of the enterprise employee to the IT system, the enterprise employee having access to the system and processing duties necessary for creation of the requests, the web portal of the system realizing an action over the request during the life cycle of the request. The method also includes processing of the request to change the access rights of the subordinate employee by the enterprise employee to define the information necessary for performance of further steps for the request processing and development of the instructions. The above-mentioned method also includes approving the request by a decision making process about granting the access to IT system resources to the subordinated employee. The method also includes requesting actualization by appointing an executor for all instructions of the request and bringing about changes in the text instructions. The method includes executing instructions by making changes in IT system condition made by appointed executors. The method may also include controlling the instruction execution by controlling the correctness of changes in access rights and conforming the changes to general instructions.

### BACKGROUND

The invention relates to information security management. The owner of information, a business manager, is responsible for information security of an enterprise, a responsibility that may flow from legal requirements or from the enterprises's own internal standards. Generally, functions of operative information security management of the enterprise are delegated to the IT (information technology) department and to the information security department. The function of the IT department is to provide IT systems so that work can get done, while the IT security department is charged with providing confidentiality of information being processed.

The ever-growing scale and capabilities of IT systems often results in at least the appearance of contradictory purposes of the IT department and the IT security department:
1. The IT department aspires to a goal that any change in the IT systems will not lead to any failure in the function of the software. Given the mission of providing a system that always works, the IT department quite often perceives the measures offered by IT-Security Department as sources of instability and delay in functioning processes of the system;
2. The IT security department considers each user of the IT system as a potential infringer of the safety and security of the system and thus aspires to limit, to the extent possible, each user's access rights to resources of the system.

Thus, the business manager wishes to be assured that all requirements of the law on information security and risks management, as well as all of the enterprises's internal standards, are stably observed. In addition, the business manager wants to be assured that funds for information security are effectively allocated and spent, and that the purchased information security systems work optimally, allowing business divisions to carry out their functions, while nonetheless providing minimally necessary access to the information.

For many users, applications, and information resources, interrelations between them become complex and varied. A variety of security facilities, as a rule, are used: both regular security facilities in operational systems and applications and specialized security facilities (for example, firewalls). For a variety of reasons, information security management is usually divided among two or more departments: the IT department is usually in charge of the regular security facilities while the IT security department manages specialized security subsystems. This leads to possible ambiguity and blurring of duties and responsibility for information security as between these departments.

Such ambiguity and blurring of the defined duties and responsibility can lead to the following negative consequences:
1. It can happen that some employees gain excessive privileges for access to IT system resources;
2. There can be a decrease of efficiency in granting or interdicting employee access to the system resources; and
3. There can be conflicts between departments due to the need to divide responsibility between the departments.

Part of maintaining security of an IT system is the development of corporate security requirements. Such requirements represent a set of policies and rules establishing, in particular, the procedure according to which any modifications are made to the IT system. The policies and rules dictate that all changes should be documented and coordinated with authorized persons according to a document work flow.

However, classical document work flow is poorly suited to information systems for the following reasons:
1. It can take far too long to coordinate a change. Often the IT department simply cannot postpone a modification in an IT system while waiting for receipt of a particular resolving document;
2. There is often only an imperfect mapping between the what appears in the documents and the system-modification actions actually undertaken. The changes actually made in the IT systems can fail to match the documentary requirements. In many cases it is difficult to track the changes;
3. A document setting forth an initial requirement often cannot describe completely all of the changes which will turn out to be necessary to make in the IT system. When one change to the IT system is made, this may require the need for other changes, absent which the ultimate goals of the requirements cannot be reached;
4. It often works out that concepts and procedures as set forth in documentary requirements are not able precisely to be interpreted by IT department employees. Likewise, IT department reports may not set forth all actions taken as clearly as would be needed to facilitate later checking and verification. Contributing to this is the differing professional lexicons employed by management and by IT department people, in discussing IT systems.

### SUMMARY

Document Oriented Adaptive Security Management Method (DOASM) is intended to implement the following functions:
1.
Automatic translation of security policy rules written in business-terms (engagement, dismissal, new duties) into technical instructions for tuning internal and external security systems.
Detection, responsibility setting and inventory of business information resources.
United and automatically coordinated identity and access management;
Automatic hard data based monitoring of compliance of actual security parameters with defined business-level security policy providing business-level notifications on non-compliances.
Automatic planning and realization of information security management document work flow (generating, adjusting and approving of formal requests for employee status changes, granting new privileges, etc).
It is perhaps helpful to review some of the aspects of the inventive system as compared with competing prior-art systems. As will be seen, while some prior-art systems try to solve some of the same problems, no known prior-art system offers all of the features and benefits of the system according to the invention.

Controllable objects. Some prior-art systems carry out centralized management by settings of controllable objects (in the operating system or in the application), basically, for WEB-applications. DOASM has the following basic advantages over such systems:
DOASM puts access management into effect not only for Web-applications but for other applications;
DOASM considers network topology at management of network devices (i.e. the relative location of the user in a network, and object of access is considered in part by adjustment of firewalls);
DOASM automatically (without intervention of managers) defines a route of coordination and statement of access requests on the basis of organizational structure and structure of resources;
DOASM realizes precise segregation of duties between IT and Security Departments on IT system management and control;
DOASM is able as to enforce automatically requested adjustments in operated systems and not to bring changes in the system, thus, not substituting for itself the regular management systems.
DOASM generates precise technical instructions which should be executed by managers by means of facilities to which they are accustomed.

DOASM has advantages compared to the prior art:
DOASM carries out access management at a level of concrete resources (files, catalogs, tables, permitted operations) and not just at a level of identifiers and user identifiers.
DOASM also automatically without intervention of managers defines a route of coordination and statement of access requests on the basis of organizational structure and structure of resources;
DOASM realizes precise segregation of duties between IT and Security Departments on IT system management and control;
DOASM also fulfills information business resources inventory and provides a definition of information owners' responsibility.

In this class of prior-art systems there is no high-grade linkage between concrete settings of information security subsystems (e.g. the development of settings on the basis of requirements of policy) and the control of execution.

In many prior-art systems there is no an automatic check for conformity of the technical parameters of the IT systems (e.g. forced updating of passwords, length of passwords) to the requirements of standards. Likewise in such prior-art systems there is no high-grade linkage with a security policy, as the paper document in business-terms (statement of problems on adjustment, the control of performance), and also communication with a process of document work flow (development, approval, statement of access request).
Some prior-art systems do attempt to carry out a linkage of business-roles and technical parameters of access, commissioning and control of the rules. But in systems of this type there is no automatic planning of information flow and realization of document work flow on development, approval, execution and control of access rules and privileges in IT systems.
Some prior-art systems realizes the preparation, approval and the formal control of document execution. But these systems do not fulfill translation of operating documents into technical instructions and do not carry out the objective control of their execution as DOASM does.

Thus, until now there has been no technology which carries out all of the integrated differentiating functions of DOASM.

One of the aspects of the present invention is a method of operating document flow within a security system. The security system comprises a server, a data base, a subsystem that has a system configuration and a Web portal, and an agent module that controls the access to the system's secured information, an IT system, the IT system being connected with changes of official, project, duties, and IT objects of the IT system, each said IT object having access to a resource type. The method includes:
developing a request to change an access right of a subordinate employee by an enterprise employee by inputting information on the change of access rights of the enterprise employee to the IT system, the enterprise employee having access to the system and processing duties necessary for creation of the requests,
the web portal of the system realizing an action over the request during the life cycle of the request.
The method also includes processing of the request to change the access rights of the subordinate employee by the enterprise employee to define the information necessary for performance of further steps for the request processing and development of the instructions.
The above-mentioned method also includes approving the request by a decision making process about granting the access to IT system resources to the subordinated employee. The method also includes requesting actualization by appointing an executor for all instructions of the request and bringing about changes in the text instructions. The method includes executing instructions by making changes in the IT system condition made by appointed executors. The method may also include controlling the instruction execution by controlling the correctness of changes in access rights and conforming the changes to general instructions.

DOASM Functions also include:
1. Operate document work flow on the basis of which business process modeling is carried out—a model of the DOASM server and a procedure of serial processing of documents connected with it change.
2. Model the IT system control facilities with adaptive feedback allowing translating changes of the information and technical resources level into organizational (business) level and back.
3. Centralize an account of changes made in the model and IT systems of the enterprise and means of the analysis interfaced to it.

Additional features and advantages of the method will be set forth in the detailed description which follows, and in part will be readily apparent to those skilled in the art from that description or recognized by practicing the method as described herein, including the detailed description which follows, the claims and the drawings.

### BRIEF DESCRIPTION OF THE DRAWINGS

FIG. 1 shows an example of Document Level Objects.

FIG. 2 shows a Request structure of Document Level Objects depicted in FIG. 1.

FIG. 3 shows an example of Business-Level Objects.

FIG. 4 shows a Role Structure of Business-Level Object depicted in FIG. 3.

FIG. 5 shows an example of Platform Objects.

FIG. 6 shows is an example of IT-level Access Subjects and Objects.

FIG. 7 shows an example of Role and Official Projections on IT-object Level depicted in FIG. 2, FIG. 3, FIG. 4, FIG. 5 and FIG. 6.

FIG. 8 is a block diagram of System Deployment with participation of W2K-AD and PKI Agents.

FIG. 9 is a block diagram of IT system data DOASM model filing.

FIG. 10 is a block diagram of Agent Emulator Deployment.

FIG. 11 is a block diagram of the DOASM Model Filing by Enterprise Organizational Structure Data.

FIG. 12 is a block diagram of Synchronization of IT-objects level with the Business-Level Objects depicted in FIG. 3.

FIG. 13 is a block diagram of Legalization of Resources depicted in FIG. 12.

FIG. 14 is a block diagram of change of a Model Condition and IT system.

FIG. 15 is a block diagram of Realization of Operating Document Flow.

FIG. 16 is a block diagram of a Request Development process depicted in FIG. 2.

FIG. 17 is a block diagram of Server Request Processing.

### DETAILED DESCRIPTION

The starting point of the system operation is the controlled information and technical environment of the enterprise, in which DOASM is deployed.

The basis of DOASM technology is a complex model of information storage (hereinafter “the DOASM Model” or “the DOASM Complex Model) uniting objects of organizational and information and technical resources of enterprises, allowing the setting of a correspondence between organizational (business) level of objects and its technological and informative projections.

The DOASM Complex Model presents a few levels of objects:
1. Document level,
2. Business—objects level,
3. IT—objects level.
   The DOASM Model paradigm has rules of object displaying at one level or another and rules of mutual relations between objects. At the document level two basic objects are examined only: Request and Instruction.

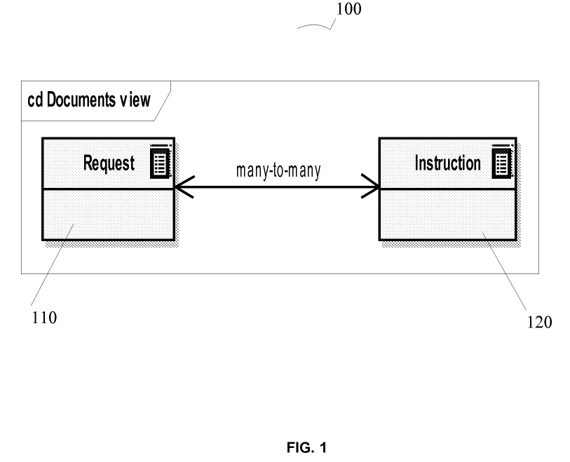

FIG. 1 is an example of Document Level Objects 100 comprising of a Request 110 and an Instruction 120. The request-object presents in the model a document containing requirements to IT systems changes expressed through business terms. The instruction-object points in the model to the atomic action for the change of IT system settings expressed through the terms of a special purpose platform. The request-object relates to a number of (zero or more) instructions. An instruction-object can relate to a great number of (one or more) requests.

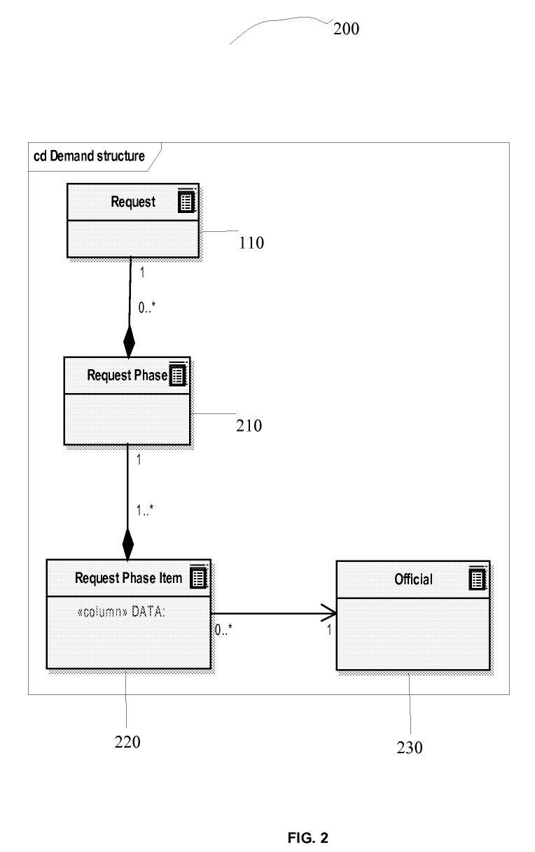

FIG. 2 shows a Request Structure 200 of Document Level Objects 100 depicted in FIG. 1. The request 100 consists of great number of phases 210, each of which is a stage of the “life cycle” treatment of the document in the system. For example, a typical case of request treatment supposes the presence of the following phases:
1. Initial processing;
2. Approval;
3. Control;
4. Actualization; and
5. Implementation.
   Every request phase 210, in its turn, consists of a great number of phase items 220 presenting the participants of the stage of treatment of the document and also additional technological parameters. For example, an approval of a request contains N of phase items 220 by a number of officials 230 taking part in approval.

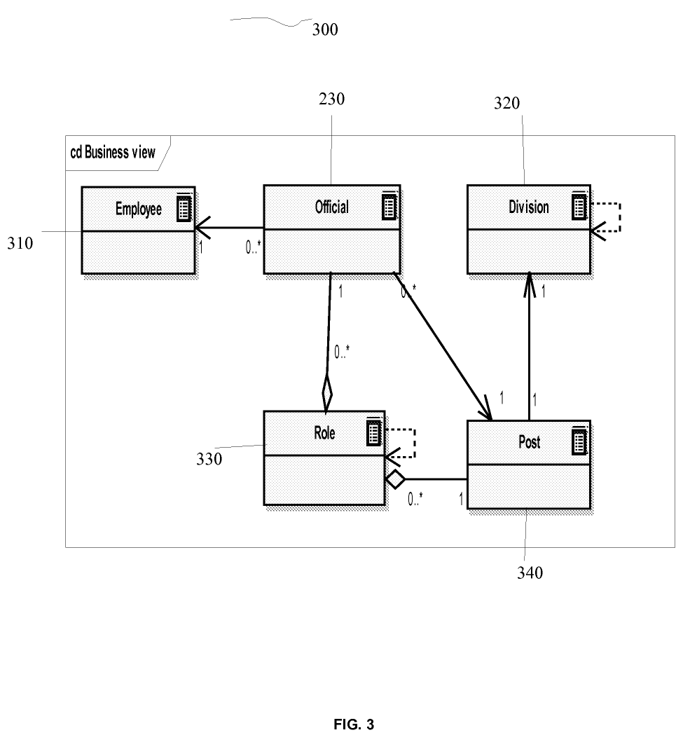

The business-objects level contains objects modeling the essence of organizational units of the enterprise (divisions of the company, posts, projects, employees and officials) and also the essence necessary for modeling basic business processes (for example, segregation of duties or rights). FIG. 3 is an example of Business-Level Objects 300. The employee-object 310 represents in the model a physical person registered in DOASM. The official-object 230 represents in the model a logic access subject, the employee appointed to a post 340. One employee 310 can be appointed to any quantity of posts 340, i.e. can have zero or more officials 230. The division-object 320 represents in the model any structural unit of the company or holding: a legal person, department, division, section, etc. Divisions form hierarchy (“tree” of divisions), where higher divisions represent larger organizational units of the company, and affiliated ones represent smaller subordinated organizational units. In the model, the post-object 340 represents a concept of permanent appointment for the concrete structural unit of the company, for example, an engineer of the analytical department, a programmer of the technical department or a secretary of the personnel department. The division can have any quantity of posts, but the post is always connected with only one division. In the model, the role-object 330 represents a concept of role-based access. The assignment of access in the business level is carried out only by means of roles. Roles 330 are appointed to access subjects (officials) directly or by means of posts. The official 230 could be connected with any quantity of roles 330. The post 340 also can be connected with any quantity of roles 330.

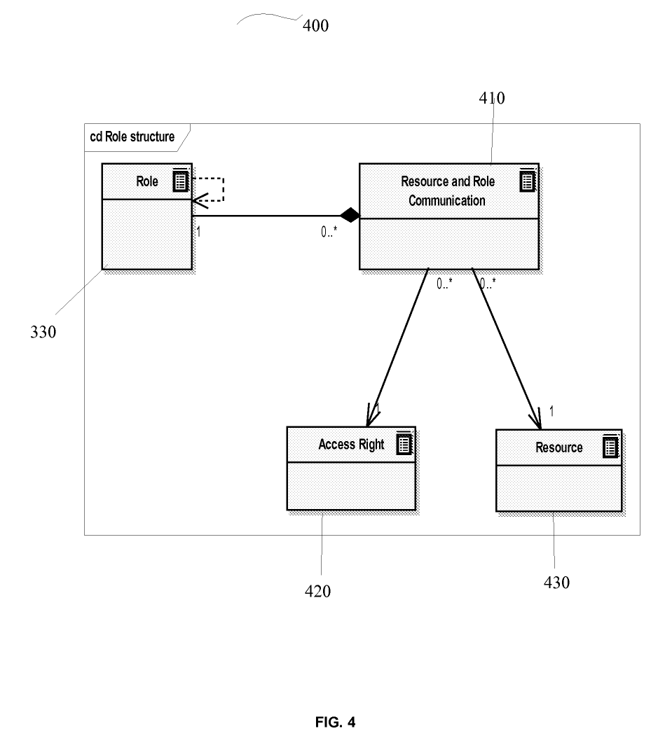

FIG. 4. is an example of the Role Structure 330 depicted in FIG. 3. Direct or indirect communication 410 (through the post) 340 of the official 230 and the role 330 is treated in DOASM as access to resources to be provided with. As regards the structure, the role 330 consists of a great number of pairs—a resource 430 and access right 420. Role 330 is an inter-platform concept, i.e. the role can contain any number of different resources 430 of various platforms and access rights 420 to them.

The IT-objects level contains objects necessary for modeling of information and technological resources of the enterprise (a platform and its copies, resources and their types, objects and subjects of logic and physical access, computers, domains, hosts, subnets, routing tables and etc.).

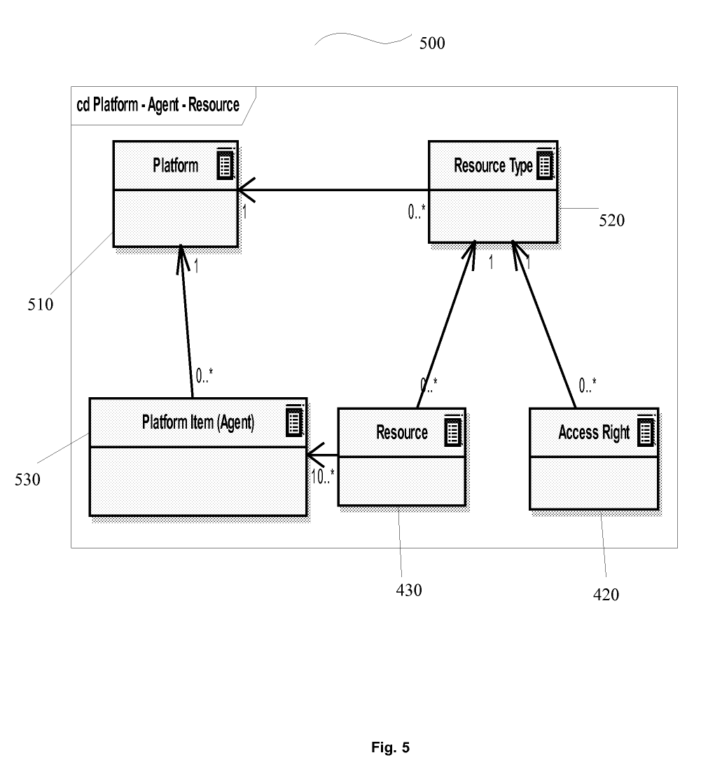

FIG. 5 is an example of Platform Objects 500. In the model, the platform-object 510 represents any class of software, service and equipment characterized by the specific nomenclature of resources types 520, access rights 420 to them and other specific properties of security settings. In the model, the agent-object 530 represents a copy of the platform and the DOASM agent software connected with it.

In the model, the resource type-object represents a resource type 520 supported by the concrete platform 510. For example, for a Windows platform such types, as a catalog and file, and for IT-Department platform—organizational units can be defined. In the model, the resource-object 430 represents an information resource, logic access object. The access right-object represents a kind of access possible for this type of resource.

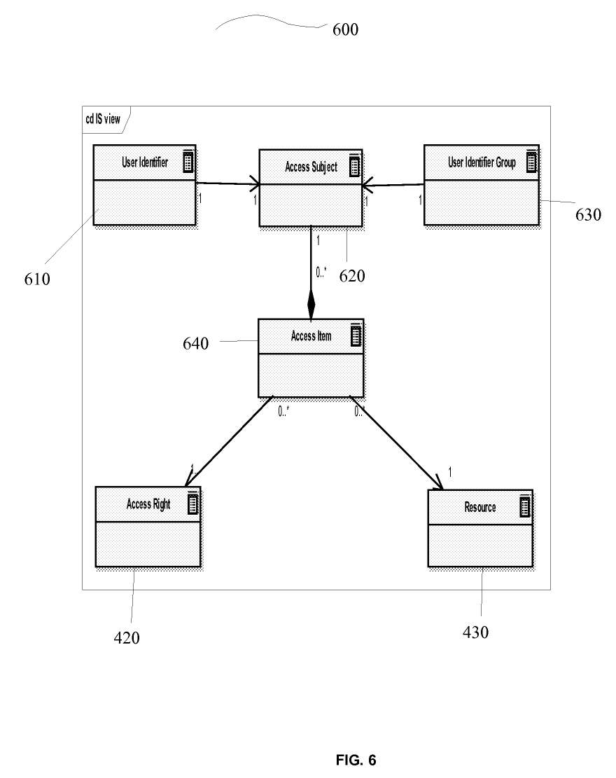

FIG. 6. shows an example of IT-level Access Subjects and Objects 600. For the description of IT-level access subjects, three objects—a generalized access subject 620, user identifier 610 and user identifier group 630 are used. In the model, the object, a generalized access subject 620, represents a user identifier 610 (or its analogues) or user identifier group 630 (or its analogues). In the model, the user identifier-object represents a user identifier 610 or its analogue for a target platform 510. In the model, the user identifier group-object represents a user identifier group 630 or its analogue for a target platform 510. The generalized access subject is characterized also by a set of objects connected with it—access items 640 uniting resources 430 and access rights 420 to them for a target platform copy (agent).

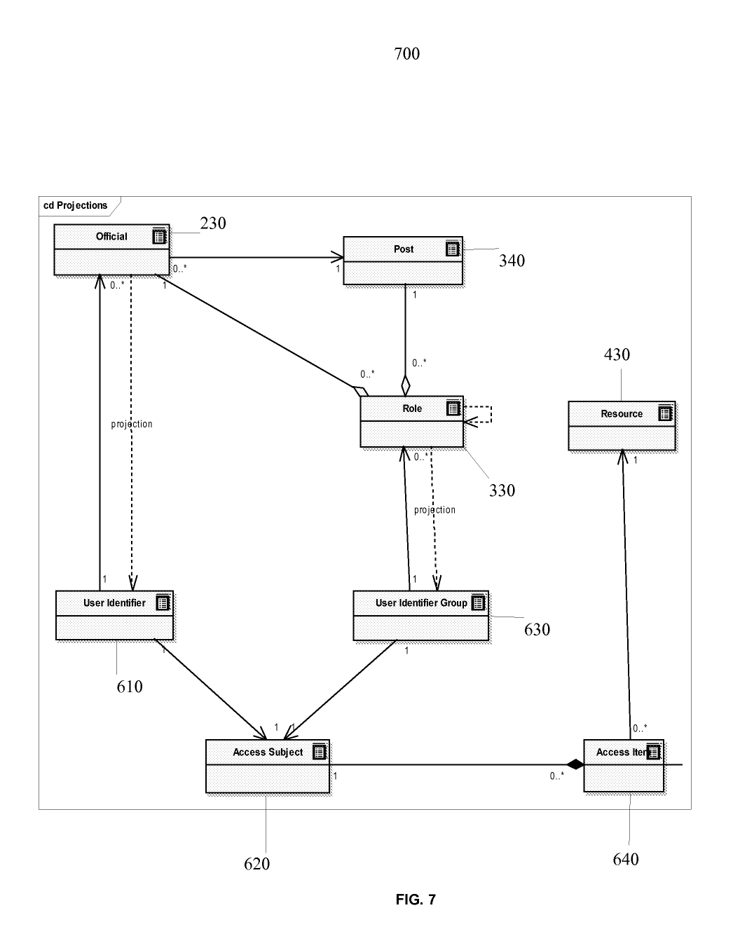

FIG. 7 is an example of the Role and Official Projections on IT-objects Level 700 as depicted in FIGS. 2, 3, 4, 5 and 6. A model of projections of these objects is used on IT-level for access management 600 on a business-object level 200. The official-object 230 is projected on user identifier 610 objects of controllable copies of platforms 510, and the role-object 330 is projected on user identifier groups 630. Thus, creation, removal, changes of direct and indirect relations and also changes of condition of the role 330 and official-objects are treated as necessity of creation, removal, change of relations or condition of corresponding projections of these objects.

Deployment in IT-objects includes installation of central, basic system items (a server and management subsystem) and also agent modules on controllable sets of the deployed software and hardware complexes.

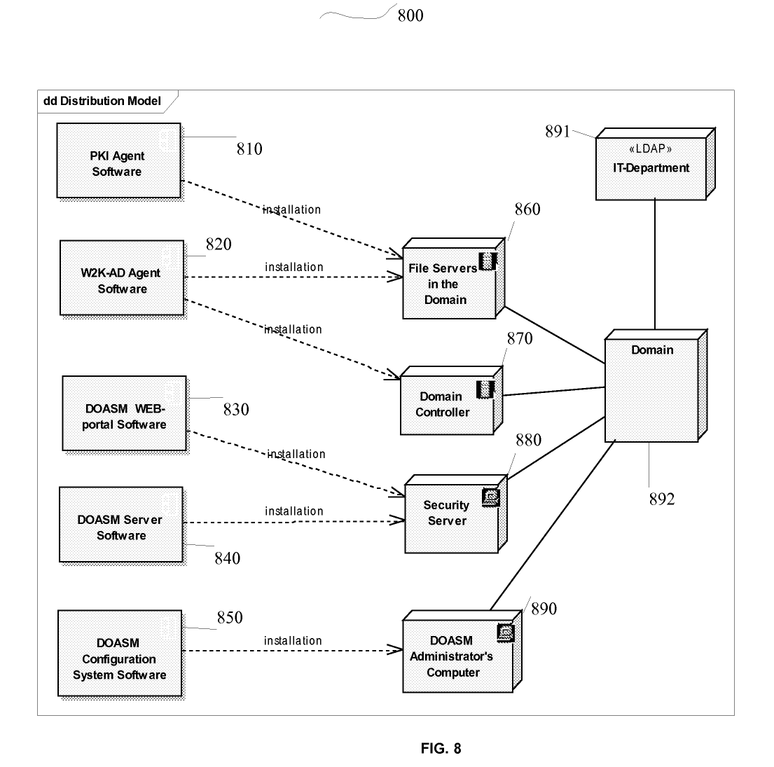

FIG. 8 is a block Diagram of System Deployment with participation of W2K-AD (Windows 2000 Active Directory) and PKI (public-key infrastructure) Agents 800. It includes installation of central, basic system items (a server 880 and management subsystem 850) and also agent modules 810, 820 on controllable sets of the deployed software 830, 840 and hardware complexes. Special requirements are shown to a hardware configuration of computers on which components of DOASM are installed. The hardware configuration should meet following minimum requirements:

| Name | Requirements |
|---|---|
| Security Server 880 | Processor Intel Pentium IV Xeon 3 GHz |
| | Random Access Memory 2048 Mb |
| | Hard Disk Controller SCSI |
| DOASM Administrator's | Processor Intel Pentium IV 1, 5 GHz |
| Computer 890 | Random Access Memory 512 Mb |

Special requirements are not provided for a domain controller 870 and file servers 860.

Construction of IT-objects model assumes filling of the system database by necessary information on a pattern of the basic DOASM model according to the fact data about the concrete IT-System.

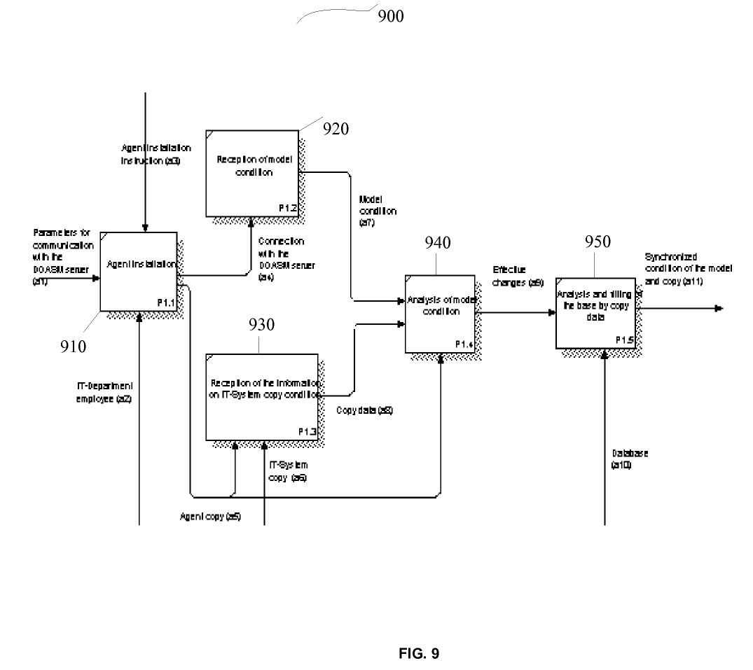

FIG. 9 is a block Diagram of IT-System data DOASM model fulfillment 900. Processes of IT-System data DOASM model fulfillment are as follows:

P1.1 Agent Installation 910 is a process of installation and adjustment of the program agent module on a server with deployed IT-objects. The input for this process is:
a1. Parameters for communication with the DOASM server—technical information necessary for installation of the DOASM agent channel with DOASM server and also maintenance of correct work of the agent (URL server), adjustment of agent's operating modes (adjustments depend on concrete realization of the agent). The resource for this process is:
a2. Employee of IT-Department is the employee of IT-Department of the enterprise making installation and adjustment of DOASM software (a server, a database, management subsystems and agent modules) and also carrying out DOASM operation (approval and actualization of requests, execution of instructions). The bases for implementation of this process is:
a3. Agent installation instruction—a document from a complete set of the DOASM documentation describing installation and adjustment process of the DOASM agent program module. The outputs of this process are:
a4. Connection with the DOASM server—a channel of the agent and DOASM server allowing them to communicate and carry out necessary interaction by means of a call of interaction interface methods; and
a5. Agent copy is a program module of DOASM realizing control mechanisms, granting of access rights and IT system copy management. Carries out monitoring of changes in IT systems and projects them on corresponding instructions or forms discrepancies (development of user identifiers, user identifier groups, etc.).

P1.2 Reception of Model Condition 920 is a process of reception by the DOASM agent of the information on condition of the model considered in the system. This process has no inputs and no basis for implementation. The resource for this process is:
a4. Connection with the DOASM server—a channel of the agent and DOASM server allowing them to communicate and carry out necessary interaction by means of a call of interaction interface methods. The output of this process is:
a7. Model condition is a system oriented description of the nomenclature of objects, their condition and interrelations. The structure and description of objects depend on a copy type of IT-Systems. It is possible to allocate user groups, users, resources and access rights to them and also their interrelations as the general objects.

P1.3 Reception of the Information on IT-System Copy Condition 930 is the process where DOASM agent carries out data gathering on IT system copy condition and also its transformation to an internal format. The structure and completeness of the collected information correspond to types of supported IT system resources. This process has no inputs and basis for implementation. The resource for this process is:
a5. Agent copy is a program module of DOASM realizing control mechanisms, granting of access rights and IT system copy management. Carries out monitoring of changes in IT systems and projects them on corresponding instructions or forms discrepancies (development of user identifiers, user identifier groups, etc.). The output of the process is:
a8. Copy data is the interconnected information on access subjects and objects describing IT system copy condition (user groups, users, resources and presented access rights, and also their interrelations).

P1.4 Analysis of Model Condition 940 is a process of data comparison describing condition of the model and data describing IT-System copy condition to find divergences between them. The inputs for this process are:
a7. Model condition is a system oriented description of the nomenclature of objects, their condition and interrelations. The structure and description of objects depend on a copy type of IT-Systems. It is possible to allocate user groups, users, resources and access rights to them and also their interrelations as the general objects, and
a8. Copy data is the interconnected information on access subjects and objects describing IT system copy condition (user groups, users, resources and presented access rights, and also their interrelations). This process has no basis for implementation. The resource for this process is:
a5. Agent copy is a program module of DOASM realizing control mechanisms, granting of access rights and IT system copy management. Carries out monitoring of changes in IT systems and projects them on corresponding instructions or forms discrepancies (development of user identifiers, user identifier groups, etc.). The output of this process is:
a9. Effective changes are when the information on objects and their interrelations, IT-System copy data and model condition absent in the description.

P1.5 Analysis and filling of the base by copy data 950 is a process of transformation and preservation of the information on IT-System copy condition in the centralized information storage of DOASM. The input for this process is:
a9. Effective changes are when the information on objects and their interrelations, IT-System copy data and model condition absent in the description. This process has no basis for implementation. The resource for this process is:
a10. Database is a subsystem of DOASM information storage and processing. Represents a uniform relational storehouse of the working information providing preservation and reference integrity of the system data. The output for this process is:
a11. Synchronized condition of the model and copy—a model of the system condition considering the information received from a new copy of IT systems and containing the information to be considered on all controllable copies of IT-Systems.

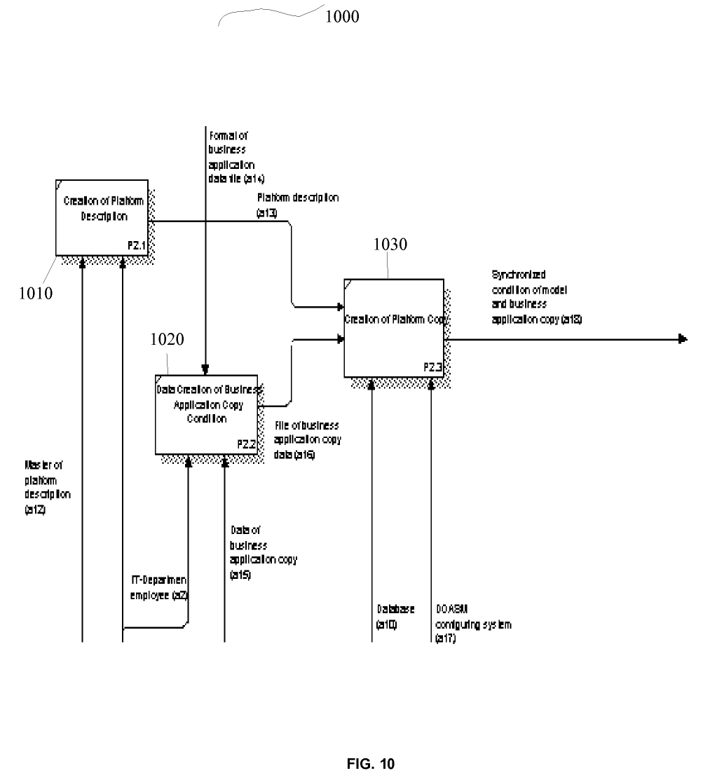

FIG. 10. is a block Diagram of Agent Emulator Deployment 1000. Agent emulator deployment (“Black Box” agent) includes following processes: P2.1 Creation of the Platform Description 1010 is a process of XML file development containing a description of the platform necessary for realization of access rights management to resources of the platform. There is no input for this process. The resources for this process are:
a12. Master of the platform description—a program module included in a complete set for DOASM administration. Presents a graphic user interface for development of the platform description;
a2. IT-Department employee is the employee of IT-Department of the enterprise making installation and adjustment of DOASM software (a server, a database, management subsystems and agent modules) and also carrying out DOASM operation (approval and actualization of requests, execution of instructions). This process has no bases for implementation. The output of this process is:
a13. Platform description is the employee of IT-Department of the enterprise making installation and adjustment of DOASM software (a server, a database, management subsystems and agent modules) and also carrying out DOASM operation (approval and actualization of requests, execution of instructions)

P2.2 Data Creation of Business Application Copy Condition 1020 is a process of creation of the text file containing data for the concrete business application copy. The file comprises nomenclature of user identifiers and user identifier groups which are present at the controllable copy and also nomenclature of resources with the access rights presented to user identifiers and groups. There is no input for this process. The resources for this process are:
a2. IT-Department employee is the employee of IT-Department of the enterprise making installation and adjustment of DOASM software (a server, a database, management subsystems and agent modules) and also carrying out DOASM operation (approval and actualization of requests, execution of instructions); and
a15. Data of the business application copy—the information of user identifiers and user identifier groups, and resources contained in this business application copy. The bases of implementation for this process is:
a14. Format of the business application data file—a document from a set of the DOASM documentation containing a description of the structure and format of the business application copy data file. The outputs of this process are:
a16. File of business application copy data is a text file having the certain structure and format containing data of business application copy.

P2.3 Creation of the Platform Copy 1030 is a process of installation and adjustment of the agent emulator for this business application copy including export of the information on a description of the platform and data of business application copy. The process is carried out by means of special masters being a part of the DOASM configuration system. The inputs for this process are:
a13. Description of the platform is the employee of IT-Department of the enterprise making installation and adjustment of DOASM software (a server, a database, management subsystems and agent modules) and also carrying out DOASM operation (approval and actualization of requests, execution of instructions), and
a16. File of business application copy data is a text file having the certain structure and format containing data of business application copy. The resources for this process are:
a10. Database is a subsystem of DOASM information storage and processing. Represents a uniform relational storehouse of the working information providing preservation and reference integrity of the system data, and
a17. DOASM configuration system is a program complex intended for performance of actions on DOASM adjustment and management. Allows carrying out of operations on administration of objects of the internal system infrastructure. It is intended for the use of IT-Department and IT-Security Department experts. This process has no basis for implementation. The output of this process is:
a18. Synchronized condition of the model and business application copy is a model of the system condition considering the received information on a new business application copy and containing the information to be considered on all controllable IT-System copies.

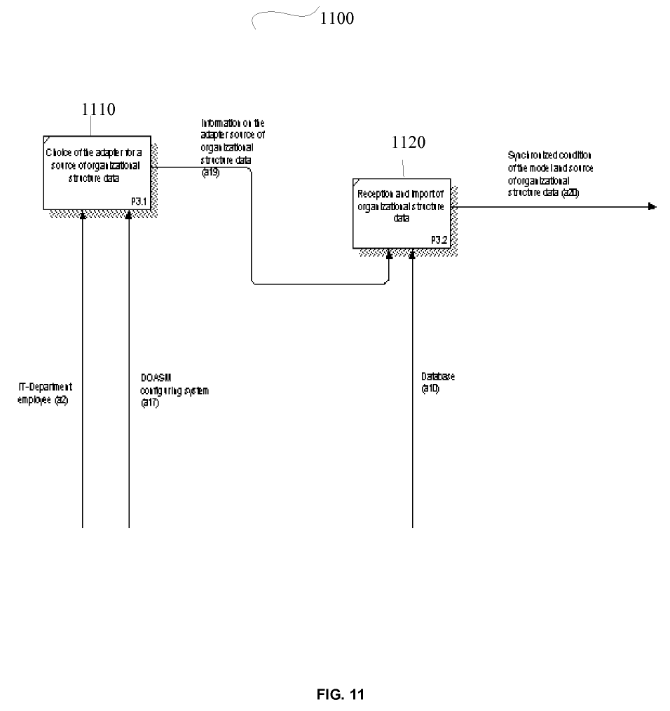

FIG. 11. is a block Diagram of the DOASM Model Filling by Enterprise Organizational Structure Data 1100. Model filling by organizational structure data includes following processes:

P3.1 Choice of the Adapter for a Source of Organizational Structure Data 1110 is a process of the choice of the special-purpose adapter for data acquisition about organizational structure from nomenclature supported by DOASM. And also, the task of special parameters for communication with the source of data and reception of the information about enterprise organizational structure. The process is carried out by means of the special-purpose master (the master of organizational structure data import) entering the configuration system. This process has no input. The resources for this process are:
a2. IT-Department employee is the employee of IT-Department of the enterprise making installation and adjustment of DOASM software (a server, a database, management subsystems and agent modules) and also carrying out DOASM operation (approval and actualization of requests, execution of instructions), and
a17. DOASM configuration system is a program complex intended for performance of actions on DOASM adjustment and management. Allows carrying out of operations on administration of objects of the internal system infrastructure. It is intended for the use of IT-Department and IT-Security Department experts. This process has no bases for implementation. The output of this process is:
a19. Information on the adapter and source of organizational structure data is a technical information necessary for maintenance of communication with the source of organizational structure data and reception of the information from it. Consists of the data adapter and parameters of communication with the source of organizational structure data.

P3.2 Reception and Import of Organizational Structure Data 1120 is a process of reception, analysis of data and their transformation to an internal format and also preservation of the information on enterprise organizational structure in the DOASM database. The inputs for this process are:
a19. Information on the adapter and source of organizational structure data is a technical information necessary for maintenance of communication with the source of organizational structure data and reception of the information from it. Consists of the data adapter and parameters of communication with the source of organizational structure data. The resource for this process is:
a10. Database is a subsystem of DOASM information storage and processing. It represents a uniform relational storehouse of the working information providing preservation and reference integrity of the system data. This process has no bases for implementation. The output for this process is:
a20. Synchronized condition of the model and source of organizational structure data is a model of the system condition considering the information on organizational structure of the enterprise (the information on a department structure, employees and their posts).

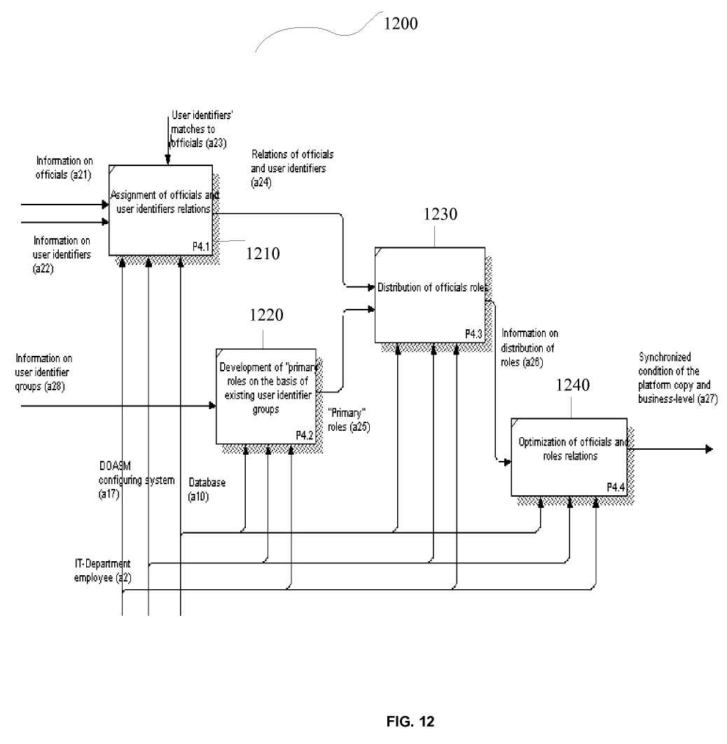

FIG. 12. Is a block Diagram of Synchronization of IT-objects level with a Business-level 1200. Synchronization of IT-objects level 500 with a business-level 300 of DOASM includes the processes as follows:

P4.1 Assignment of Officials and User Identifiers Relations 1210 is a process of comparison of officials and user identifiers. The process is carried out by IT-Department employee by means of a special-purpose master (the master of synchronization) entering the DOASM configuration system. The inputs for this process are:
a21. Information on officials is a list of enterprise officials and also information on them, and
a22. Information on user identifiers is a list of user identifiers got by IT-objects. The resources for this process are:
a2. IT-Department employee is the employee of IT-Department of the enterprise making installation and adjustment of DOASM software (a server, a database, management subsystems and agent modules) and also carrying out DOASM operation (approval and actualization of requests, execution of instructions),
a17. DOASM configuration system is a program complex intended for performance of actions on DOASM adjustment and management. Allows carrying out of operations on administration of objects of the internal system infrastructure. It is intended for the use of IT-Department and IT-Security Department experts, and
a10. Database is a subsystem of DOASM information storage and processing. It represents a uniform relational storehouse of the working information providing preservation and reference integrity of the system data. The bases for implementation for this process is:
a23. Conformity of user identifiers to employees is the information on interrelation of officials of the enterprise with user identifiers. The output of this process is:
a.24. Relations of officials and user identifiers is a set of user identifiers' matches to officials.

P4.2 Development of “Primary” Roles on the Basis of Existing User Identifier Groups 1220 is a process of creation and preservation of primary roles in the database. Primary roles are business-level objects, unequivocally relate to user identifier groups (one role corresponds to each user identifier group) and have the similar name. The input for this process is:
a28. Information on user identifier groups is a list of user identifier groups created in IT-objects. The resource for this process is:
a2. IT-Department employee is the employee of IT-Department of the enterprise making installation and adjustment of DOASM software (a server, a database, management subsystems and agent modules) and also carrying out DOASM operation (approval and actualization of requests, execution of instructions),
a17. DOASM configuration system is a program complex intended for performance of actions on DOASM adjustment and management. Allows carrying out of operations on administration of objects of the internal system infrastructure. It is intended for the use of IT-Department and IT-Security Department experts, and
a10. Database is a subsystem of DOASM information storage and processing. It represents a uniform relational storehouse of the working information providing preservation and reference integrity of the system data. There is no bases for implementation for this process. The output for this process is:
a25. “Primary” roles is a list of primary roles created on the basis of the information on user identifier groups of the enterprise.

P4.3 Distribution of Officials Roles 1230 is a process of analysis and assignment of roles created in the system to officials. Assignment of roles to officials is made on the basis of the information on distribution of user identifiers to groups and employees' belonging to posts. The inputs for this process are:
24. Relations of officials and user identifiers is a set of user identifiers' matches to officials, and
a25. “Primary” roles is a list of primary roles created on the basis of the information on user identifier groups of the enterprise. The resources for this process are:
a2. IT-Department employee is the employee of IT-Department of the enterprise making installation and adjustment of DOASM software (a server, a database, management subsystems and agent modules) and also carrying out DOASM operation (approval and actualization of requests, execution of instructions),
a17. DOASM configuration system is a program complex intended for performance of actions on DOASM adjustment and management. Allows carrying out of operations on administration of objects of the internal system infrastructure. It is intended for the use of IT-Department and IT-Security Department experts, and
a10. Database is a subsystem of DOASM information storage and processing. It represents a uniform relational storehouse of the working information providing preservation and reference integrity of the system data. There is no bases for implementation for this process. The output for this process is:
a26. Information on distribution of roles is a set of role assignments to officials of the enterprise.

P4.4 Optimization of Officials and Roles Relations 1240 is a process of correcting and optimizing actions of IT-Department employees to be performed as regards the set of matches of officials and roles received as a result of distribution. The input for this process is:
a26. Information on distribution of roles is a set of role assignments to officials of the enterprise. The resources for this process are:
a2. IT-Department employee is the employee of IT-Department of the enterprise making installation and adjustment of DOASM software (a server, a database, management subsystems and agent modules) and also carrying out DOASM operation (approval and actualization of requests, execution of instructions),
a17. DOASM configuration system is a program complex intended for performance of actions on DOASM adjustment and management. Allows carrying out of operations on administration of objects of the internal system infrastructure. It is intended for the use of IT-Department and IT-Security Department experts, and
a10. Database is a subsystem of DOASM information storage and processing. It represents a uniform relational storehouse of the working information providing preservation and reference integrity of the system data. There is no bases for implementation for this process. The output for this process is:
a27. Synchronized condition of the platform copy and business-level—a system model considering interrelations between business-level objects (officials and roles) and IT system level objects (user identifiers and user identifier groups).

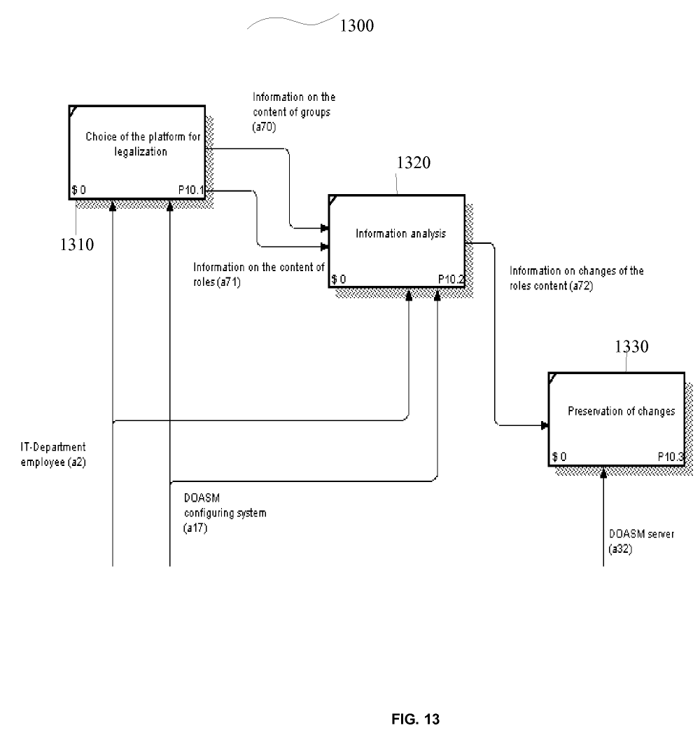

FIG. 13 is a block diagram of Legalization of Resources 1300 depicted in FIG. 12. Legalization of resources includes following processes:

P10.1 Choice of the Platform for Legalization 1310 is a process of the platform choice by IT-Department employee. It is necessary to carry out legalization of resources and access rights to them. There is no input for this process. The resources for this process are:
a2. IT-Department employee is the employee of IT-Department of the enterprise making installation and adjustment of DOASM software (a server, a database, management subsystems and agent modules) and also carrying out DOASM operation (approval and actualization of requests, execution of instructions),
a17. DOASM configuration system is a program complex intended for performance of actions on DOASM adjustment and management. Allows carrying out of operations on administration of objects of the internal system infrastructure. It is intended for the use of IT-Department and IT-Security Department experts. There is no bases for implementation for this process. The outputs for this process are:
a70. Information on the content of groups—the information on resources and access rights to them represented by the group, and
a71. Information on the content of roles—the information on resources and access rights to resources represented by the role.

P10.2 Information Analysis 1320 is a process of roles and groups content analysis to find the information on resources and access rights to resources present in groups, but not considered in the roles connected with them. The inputs for this process are:
a70. Information on the content of groups—the information on resources and access rights to them represented by the group, and
a71. Information on the content of roles—the information on resources and access rights to resources represented by the role.
a2. IT-Department employee is the employee of IT-Department of the enterprise making installation and adjustment of DOASM software (a server, a database, management subsystems and agent modules) and also carrying out DOASM operation (approval and actualization of requests, execution of instructions),
a17. DOASM configuration system is a program complex intended for performance of actions on DOASM adjustment and management. Allows carrying out of operations on administration of objects of the internal system infrastructure. It is intended for the use of IT-Department and IT-Security Department experts. There is no bases for implementation for this process. The output for this process is:
a72. Information on changes of the roles content—the information on the chosen resources and access rights to them which have not been considered in the content of roles.

P10.3 Preservation of Changes 1330 is a process of preservation of the revealed changes in the system database. The input for this process is:
a72. Information on changes of the roles content—see outputs of the process “P10.2 Information Analysis”. The resource for this process is:
a32. DOASM server—see resources of the process “P5.2 Reception and the Beginning of Processing”. The process has no bases for implementation and no output.

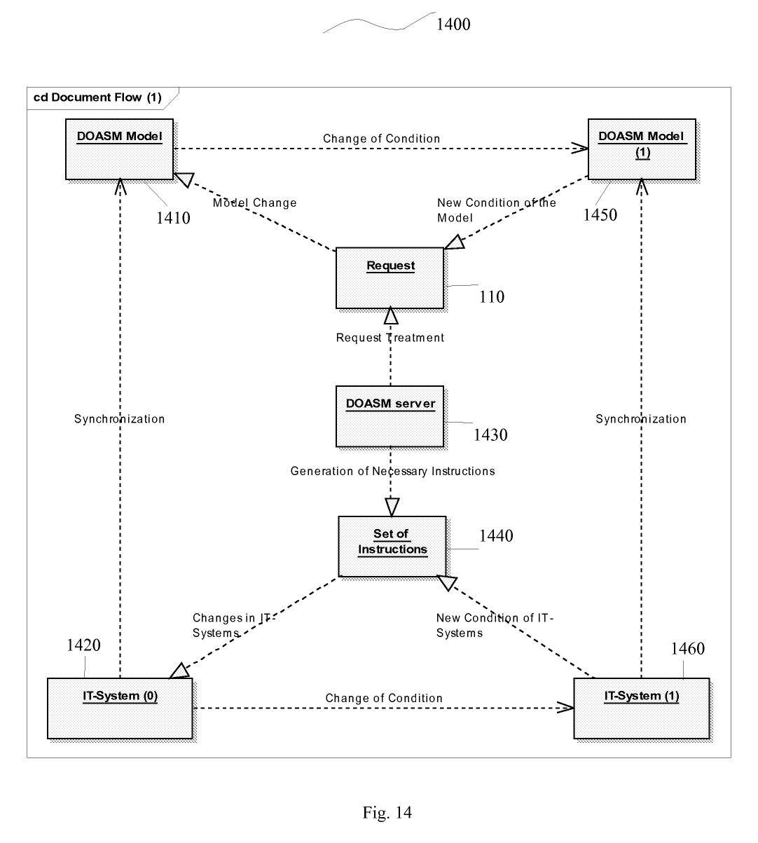

FIG. 14. is a block diagram of Change of the Model Condition and IT-Systems 1400. Modeling of enterprise processes on the basis of document flow is based on a paradigm of two components—Requests 110 and Instructions 120. Basis of enterprise process modeling—modification in the DOASM Model 1410, is an electronic document-request 110. The request 110 defines the list of operations for the change of the model. Changes in the model are translated by the system into instructions 1440 are atomic actions on the change of IT-objects. The list of operations of the request is processed by DOASM server, represents characteristic business procedures—acceptance for work and dismissal of employees, their appointment and moving from posts, providing with duties and rights, etc. Instructions 1440 generated by DOASM server 1430 define actions on the change of IT-objects necessary for performance of request requirements expressed through the terms corresponding to software or hardware items for which they are intended. The model 1410, 1450 and IT-Systems 1420, 1460 are in mutually synchronized condition, i.e. the model condition corresponds to IT-Systems condition. The change of the model condition caused by a request leads to generation of instructions, at their performance the model and IT-Systems go to a new synchronized condition.

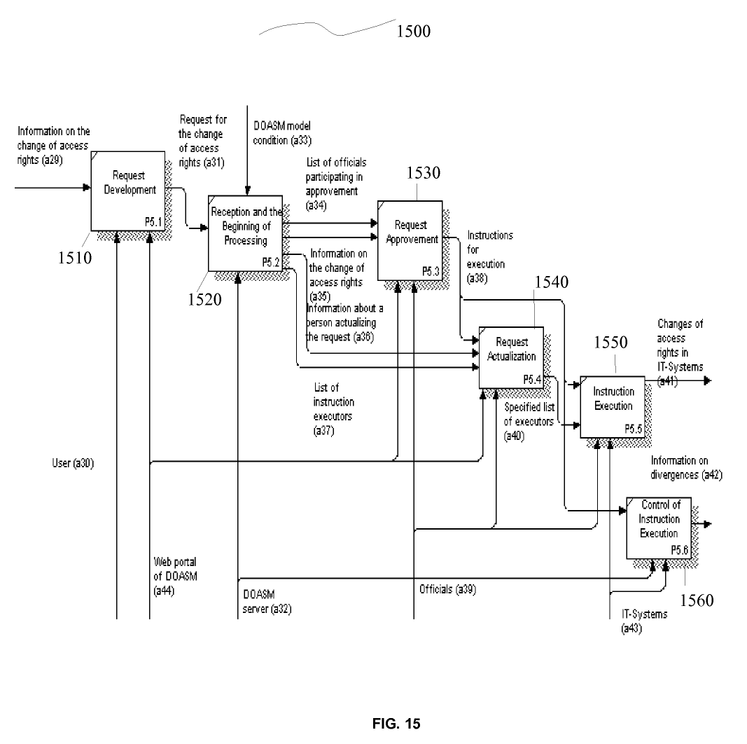

Realization of operating document flow is an automated business-process directed to approval of the document and approved distribution of received instructions among executors. FIG. 15 is a block Diagram of Realization of Operating Document Flow 1500. Realization of operating document flow includes following processes:

P5.1 Request Development 1510 is a process to create a request 110 for changes of access rights 420 of subordinated employees by an enterprise employee. The process is carried out by means of a special-purpose master included in Web portal of DOASM for creation of the request. The inputs for this process are:
a29. Information on the change of access rights 420 is the information on necessity to change access rights of the enterprise employee to IT-Systems 1420 connected with the change of official 230, project or other duties,
a30. User is an enterprise employee having access to DOASM and possessing duties necessary for creation of requests, and
a44. Web portal of DOASM is a program complex intended for realization of actions over requests during all life cycle of the request and also reception of information reports. It is intended for the use by employees of the enterprise. The process has no basis for implementation. The output for this process is:
a31. Request for the change of access rights is in-system document containing the information on employees and changes of access rights necessary for them and also the service information (date of creation, the information on the founder, etc.) necessary for work of the system.

P5.2 Reception and the Beginning of Processing 1520 is a process of checking and processing of the request to define the information necessary for performance of further steps for request processing (approval, actualization and execution of the request) and also development of technical instructions. The process is carried out by the DOASM server 1430. The inputs for this process are:
a31. Request for the change of access rights is in-system document containing the information on employees and changes of access rights necessary for them and also the service information (date of creation, the information on the founder, etc.) necessary for work of the system. The resource for this process is:
a32. DOASM server is a program complex realizing the basic logic of DOASM, carrying out interaction and approval of works of other system components and also preservation of the information in the database. The bases for implementation for this process is:
a33. DOASM model condition 1410 is the system information on requests, instructions, user groups, users, roles and access rights, and also other service information influencing the process of development and processing of the request for the change of access rights. The outputs of this process are:
a34. List of approving officials is a list of officials whose approval of the request for granting of access rights is necessary. The list of officials whose approval for the further processing of the request is necessary. The list is defined by the DOASM server on the basis of the information on resources, the access to which is presented in the request;
a35. Information on the change of access rights is the information on changes in IT-Systems necessary for granting of access rights to the employee. The information is received on the basis of the processed request and is kept in the internal format;
a36. Information about a person actualizing the request is the official whose duties are included in the process of request actualization (appointment of executors to perform instructions of the request). The actualizing person is defined by the server on the basis of the information contained in the request; and
a37. List of instruction executors is a list of officials appointed to execution of request instructions. The information on executors is created by the server on the basis of necessary changes in IT-Systems, and also information on employees responsible for IT-System data.

P5.3 Request Approval 1520 is a process of decision-making about granting of access to IT-System resources to the employee. The process is carried out by officials participating in approval by means of Web portal of DOASM. The inputs for this process are:
a34. List of officials participating in approval is a list of officials whose approval of the request for granting of access rights is necessary. The list of officials whose approval for the further processing of the request is necessary. The list is defined by the DOASM server on the basis of the information on resources, the access to which is presented in the request, and
a35. Information on the change of access rights is the information on changes in IT-Systems necessary for granting of access rights to the employee. The information is received on the basis of the processed request and is kept in the internal format. The resources for this process are:
a44. Web portal of DOASM is a program complex intended for realization of actions over requests during all life cycle of the request and also reception of information reports. It is intended for the use by employees of the enterprise, and
a39. Officials—the employees of the enterprise possessing necessary duties for realization of actions on processing of the request in DOASM. The process has no basis for implementation. The outputs of this process is:
a38. Instructions for execution is a list of technical instructions (in the internal format), execution of which is necessary for the change of access rights of the employee in IT-Systems. The list of instructions is formed by the DOASM server on the basis of the information contained in the request, and also depending on the DOASM model condition.

P5.4 Request Actualization 1540 is a process of appointment of executors for all instructions of the request and also bringing changes in the text of instructions. The process is carried out by the official responsible for actualization of the request by means of Web portal of DOASM. The inputs for this process are:
a36. Information about a person actualizing the request is the official whose duties are included in the process of request actualization (appointment of executors to perform instructions of the request). The actualizing person is defined by the server on the basis of the information contained in the request,
a37. List of instruction executors is a list of officials appointed to execution of request instructions. The information on executors is created by the server on the basis of necessary changes in IT-Systems, and also information on employees responsible for IT-System data, and
a38. Instructions for execution is a list of technical instructions (in the internal format), execution of which is necessary for the change of access rights of the employee in IT-Systems. The list of instructions is formed by the DOASM server on the basis of the information contained in the request, and also depending on the DOASM model condition. The resources for this process are:
a44. Web portal of DOASM is a program complex intended for realization of actions over requests during all life cycle of the request and also reception of information reports. It is intended for the use by employees of the enterprise, and
a39. Officials are the employees of the enterprise possessing necessary duties for realization of actions on processing of the request in DOASM. This process has no basis for implementation. The output of this process is:
a40. Specified list of executors—a list of executors of technical instructions which has been corrected on the basis of a current personnel situation (workload of employees, presence of employees on a workplace, etc.). It is necessary to make changes in IT-objects (on the basis of instructions) for these executors.

P5.5 Instruction Execution 1550 is a process of bringing changes in IT-System condition made by appointed executors on the basis of technical instructions generated by DOASM. The inputs for this process are:
a38. Instructions for execution is a list of technical instructions (in the internal format), execution of which is necessary for the change of access rights of the employee in IT-Systems. The list of instructions is formed by the DOASM server on the basis of the information contained in the request, and also depending on the DOASM model condition,
a40. Specified list of executors—a list of executors of technical instructions which has been corrected on the basis of a current personnel situation (workload of employees, presence of employees on a workplace, etc.). It is necessary to make changes in IT-objects (on the basis of instructions) for these executors. The resources for this process are:
a39. Official are the employees of the enterprise possessing necessary duties for realization of actions on processing of the request in DOASM, and
a43. IT systems are IT-objects. All IT-objects, access rights to the resources of which are supervised by DOASM. This process has no basis for implementation. The output for this process is:
a41. Changes of access rights in IT-Systems—modification in IT-objects to change access rights according to the received instructions.

P5.6 Control of Instruction Execution 1560 is a process of the control of correctness for changes of access rights and conformity of changes to the generated instructions. The input for this process is:
a38. Instructions for execution is a list of technical instructions (in the internal format), execution of which is necessary for the change of access rights of the employee in IT-Systems. The list of instructions is formed by the DOASM server on the basis of the information contained in the request, and also depending on the DOASM model condition. The resources for this process are:
a43. IT systems are IT-objects. All IT-objects, access rights to the resources of which are supervised by DOASM. This process has no basis for implementation, and
a32. DOASM server is a program complex realizing the basic logic of DOASM, carrying out interaction and approval of works of other system components and also preservation of the information in the database. This process has no bases for implementation. The output for this process is:
a42. Information on divergences—registered in DOASM information of events on the change of access rights and IT-System objects coherent with them, realization of which has taken place without development of technical instructions on changes.

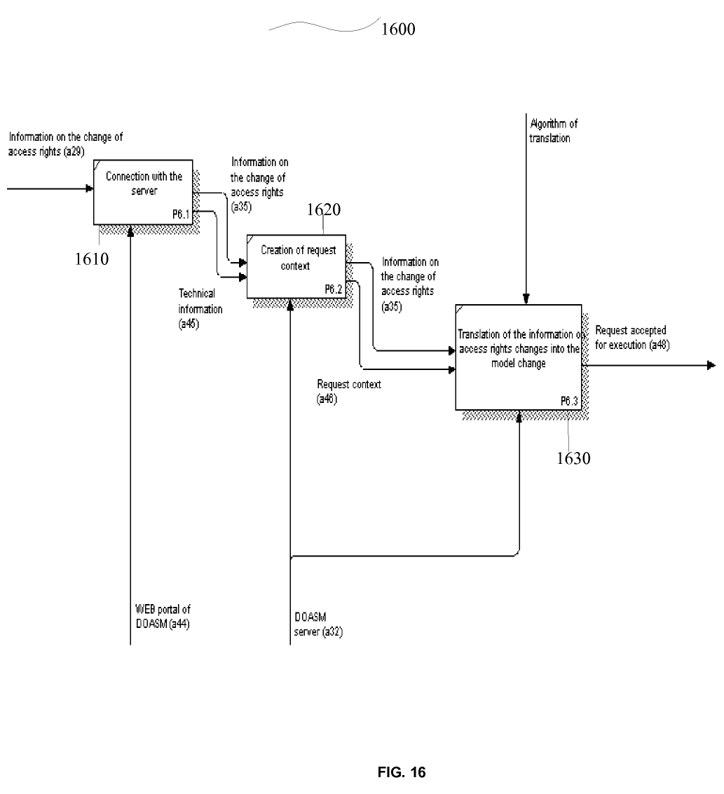

FIG. 16. is a block Diagram of a Request Development Process 1600. Request development 110 in DOASM includes following processes:

P6.1 Connection with the server 1610 is a process of creation of the Web portal and DOASM server channel allowing them to communicate and carry out necessary interaction by means of a call of methods of the interaction interface. The input for this process is:
a29. Information on the change of access rights 420 is the information on necessity to change access rights of the enterprise employee to IT-Systems 1420 connected with the change of official 230, project or other duties. The resource for this process is:
a44. Web portal of DOASM is a program complex intended for realization of actions over requests during all life cycle of the request and also reception of information reports. It is intended for the use by employees of the enterprise. This process has no bases for implementation. The outputs of this process are:
a35. Information on the change of access rights is the information on changes in IT-Systems necessary for granting of access rights to the employee. The information is received on the basis of the processed request and is kept in the internal format, and
a45. Technical information—the technical information necessary for correct processing of the request (time of creation, founder of the request, etc.).

P6.2 Creation of the Request Context 1620 is creation of technical objects on the server necessary for further processing of the request. The inputs for this process are:
a35. Information on the change of access rights is the information on changes in IT systems necessary for granting of access rights to the employee. The information is received on the basis of the processed request and is kept in the internal format, and
a45. Technical information—the technical information necessary for correct processing of the request (time of creation, founder of the request, etc.). The resource for this process:
a32. DOASM server is a program complex realizing the basic logic of DOASM, carrying out interaction and approval of works of other system components and also preservation of the information in the database. This process has no bases for implementation. The outputs of this process are:
a35. Information on the change of access rights is the information on changes in IT-Systems necessary for granting of access rights to the employee. The information is received on the basis of the processed request and is kept in the internal format access rights, and
a46. Request context—nomenclature of technical objects necessary for further processing of the request.

P6.3 Translation of the Information on Access Rights Changes into the Model Change 1630 is a translation of changes of business-level objects (official, post, role) and relations between them into technical objects (user identifier, user identifier groups, access rights to resources) and their interrelations. The inputs for this process are:
a35. Information on the change of access rights is the information on changes in IT-Systems necessary for granting of access rights to the employee. The information is received on the basis of the processed request and is kept in the internal format access rights, and
a46. Request context—nomenclature of technical objects necessary for further processing of the request. The resource for this process is:
a32. DOASM server is a program complex realizing the basic logic of DOASM, carrying out interaction and approval of works of other system components and also preservation of the information in the database. The basis for implementation for this process is:
a47. Algorithm of translation—a set of translation rules necessary for translation of business-level objects (official, post, role) and relations between them into technical objects (user identifiers, user identifier groups, access rights to resources) and their interrelations. The output of this process is:
a48. Request accepted for execution—a group of interconnected internal objects of the system containing the information necessary for realization of the request processing and development of instructions for changes in IT-Systems.

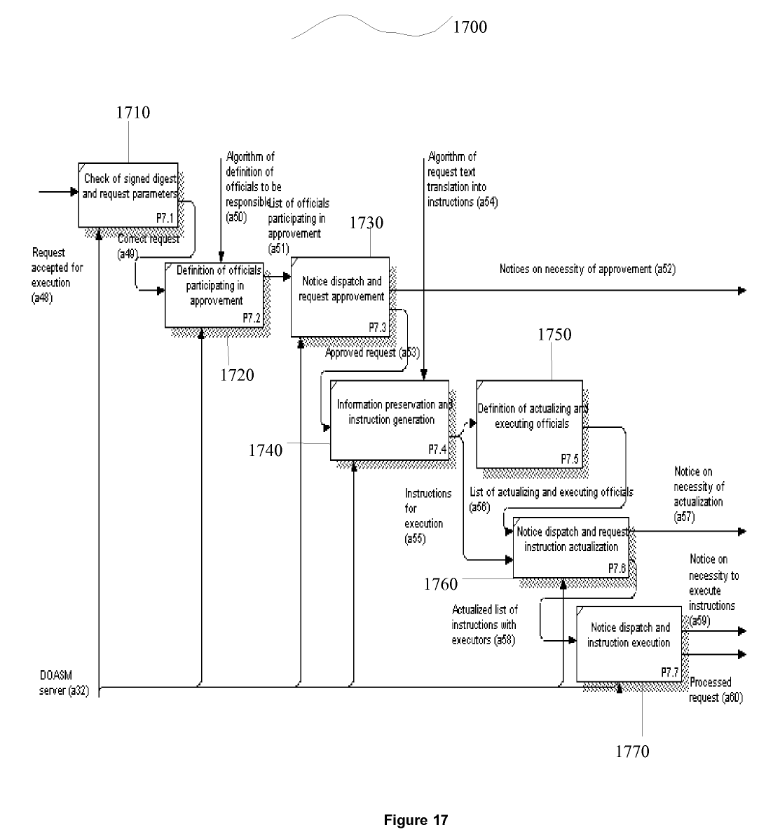

FIG. 17. is a Diagram of Server Request Processing 1700. Server request processing includes the following processes:

P7.1 Check of Signed Digest and Request Parameters 1710 is a process of the server check of correctness of signed digest of the employee who has made the request and also checking of request conformity to the current condition of the DOASM model. The input for this process is:
a48. Request accepted for execution—see output of the process “P6.3 Translation of the Information on Access Rights Changes into the Model Change”. The resource for this process is:
a32. DOASM server—see resources of the process “P5.2 Reception and the Beginning of Processing”. There is no bases for implementation for this process. The output of this process:
a49. Correct request—a request checked on the server;

P7.2 Definition of Officials Participating in Approval 1720 is a process of reception of the information and definition of the list of officials whose approval is necessary for granting of access rights. The input of this process is:
a49. Correct request—see output of the process “P7.1 Check of Signed Digest and Request Parameters”. The resource for this process is:
a32. DOASM server—see resources of the process “P5.2 Reception and the Beginning of Processing”. The basis for implementation for this process is:
a60. Algorithm of definition of officials to be responsible—a set of rules based on the mechanism of duties for the control of access to resources to which access rights are to be changed. The output for this process is:
a51. List of officials participating in approval—a list of officials whose approval is necessary for the change of access to IT-System resources.

P7.3 Notice Dispatch and Request Approval 1730 is a process of notice dispatch and carrying out of approval by all officials participating in request approval. The input for this process is:
a51. List of officials participating in approval—see output of the process “P7.2 Definition of Officials Participating in Approval”. Resource for this process is:
a32. DOASM server—see resources of the process “P5.2 Reception and the Beginning of Processing”. There is no bases for implementation of this process. The outputs of this process are:
a52. Notices on necessity of approval—sending of post letters informing a necessity to hold request approval;
a53. Approved request—a request approved by all officials whose approval was necessary for further processing of the request.

P7.4 Information Preservation and Instruction Generation 1740 is creation of technical instructions for changes in IT systems and preservation of the information about them in the database. The input for this process is:
a53. Approved request—see outputs of the process “P7.3 Notice Dispatch and Request Approval”. The resource for this process is:
a32. DOASM server—see resources of the process “P5.2 Reception and the Beginning of Processing”. Bases for implementation for this process is:
a54. Algorithm of the request text translation into instructions—rules of development of technical instructions for changes in IT-Systems. The algorithm contains rules of transformation of business-level operations into technical instructions for changes in IT-Systems. The output for this process is:
a55. Instructions for execution—technical instructions containing atomic operations on IT-System adjustments (for example: to create a group, login, to include the login in the group, etc.).

P7.5 Definition of Actualizing and Executing Officials 1750 is process of reception of the information and definition of the list of officials that should carry out actualization of request instructions and their execution. The input for this process is:
a55. Instructions for execution—see output of the process “P7.4 Information Preservation and Instruction Generation”. The resource for this process is:
a32. DOASM server—see resources of the process “P5.2 Reception and the Beginning of Processing”. The process has no bases for implementation. The output for this process is:
a56. List of actualizing and executing officials—a list of officials who should implement actualization of request instructions (specify executors and if necessary, to edit the text of instructions) and also execution of these instructions (bringing of necessary changes into IT-objects).

P7.6 Notice Dispatch and Request Instruction Actualization 1760 is a process of notice dispatch on necessity of carrying out of request actualization and its current status. And also process of actualization, appointment or approval of the appointed executors of instructions and taking changes into the text of instructions (if necessary). The inputs for this process are:
a55. Instructions for execution—see output of the process “P7.5 Definition of Actualizing and Executing Officials”; and
a56. List of actualizing and executing officials—see output of the process “P7.5 Definition of Actualizing and Executing Officials”. The resource for this process is:
a32. DOASM server—see resources of the process “P5.2 Reception and the Beginning of Processing”. This process has no bases for implementation. The outputs for this process is:
a57. Notice on necessity of actualization—sending of post notifications about necessity to hold actualization of request instructions; and
a58. List of instructions actualized with executors—a list of instructions for modification in IT-Systems and also executors appointed for every instruction.

P7.7 Notice Dispatch and Instruction Execution 1770 is a process of a notice dispatch on necessity to execute instructions and also the control of IT-System changes and their alignment with instructions. The input for this process is:
a58. Actualized list of instructions with executors—see output of the process “P7.6 Notice Dispatch and Request Instruction Actualization”. The resource for this process is:
a32. DOASM server—see resources of the process “P5.2 Reception and the Beginning of Processing”. The process has no basis for implementation. The outputs for this process are:
a59. Notice on necessity to execute instructions—sending of post notifications about necessity to execute instructions and make changes in IT-Systems; and
a60. Processed request—a request all instructions of which are executed and changes corresponding them have been made in IT-objects.

It should be noted that the matter contained in the above description or shown in accompanying drawings should be interpreted as illustrative and not in a limited sense. The following claims are intended to cover all generic and specific features described herein, as well as all statements of the scope of the present method and system, which, as a matter of language, might be said to fall there between.

1. A method of operating document flow within a security system, the security system comprising a server, a data base, a subsystem that has a system configuration and a Web portal, and an agent module that controls the access to the system's secured information, an IT system, the IT system being connected with changes of official, project, duties, and IT-objects of IT system, each said IT-object having access to a resource type, the method comprising the steps of:
developing a request to change an access right of a subordinate employee by an enterprise employee by inputting information on the change of access rights of the enterprise employee to the IT system, the enterprise employee having access to the system and processing duties necessary for creation of the requests, the web portal of the system realizing an action over the request during the life cycle of the request;
processing of the request to change the access rights of the subordinate employee by the enterprise employee to define the information necessary for performance of further steps for the request processing and development of the instructions;
approving the request by a decision making process about granting the access to IT system resources to the subordinated employee;
requesting actualization by appointing an executor for all instructions of the request and bringing about changes in the text instructions;
executing instructions by making changes in IT system condition made by appointed executors; and
controlling the instruction execution by controlling the correctness of changes in access rights and conforming the changes to general instructions.

2. The method of claim 1, wherein the output of the request to change the access rights is an in-system document containing information on employees and changes of access rights and service information required the working of the IT system.

3. The method of claim 1, wherein the request for change is carried out by means of a special-purpose master included in the Web portal of the security system.

4. The method of claim 1, wherein the processing of the request to change the access rights is performed by the server utilizing a digital signature of an official whose approval of the request is necessary to grant the access rights.

5. The method of claim 1, wherein the processing of the request to change the access rights further comprises the steps of:
inputting the output of the request to change the access rights in the in-system document;
using a program on the server that realizes the basic logic of the system security, carries out the interaction and improvement of working system components and preserves the information from the data base containing an inventory of IT system resources to which access is managed and an identifier of official responsible for these resources;
inputting the system information on requests, instructions, user groups, users and access rights;
outputting a list of officials whose approval of the request for granting of access rights is necessary, the list defined by the server automatically based on resources to which access is requested and responsibility for these resources;
outputting information on changes in the IT system necessary for granting the access right to the subordinate employee;
outputting information about an official whose duties are included in the process of request actualization, the actualizing person defined by the server on the information contained in the request; and
outputting a list of officials appointed for execution of the request instructions, the information on executors created by the server on the basis of changes in the IT system.

6. The method of claim 5, wherein approving the request by a decision making process about granting the access to IT system resources to the subordinate employee further comprises the steps of:
inputting the list of officials whose approval of the request for granting of access rights is necessary, the list defined by the server automatically based on resources to which access is requested and responsibility for these resources;
inputting the information on changes in the IT system necessary for granting the access right to the subordinated employee;
using a program on the server that realizes the basic logic of the system security, carries out the interaction and improvement of the working system components and preserves the information from the data base;
downloading a list of the enterprise employees possessing necessary authority for realization of actions on processing of the request; and
outputting by the systems server the list of the technical instructions execution of which is necessary for the change in access rights by the subordinated employee in the IT system.

7. The method of claim 6, wherein requesting actualization by appointing an executor for all instructions of the request further comprising the steps of:
inputting information about an official whose duties are included in the process of request actualization, the actualizing person defined by the server on the information contained in the request;
inputting the list of officials appointed for execution of the request instructions, the information on executors created by the server on the basis of changes in the IT system;
inputting the list of the technical instructions execution of which is necessary for the change in access rights by the subordinate employee in the IT system;
using a program complex intended to realize an action over the request during the life cycle of the request;
downloading a list of the enterprise employees possessing necessary authority for realization of actions on processing of the request; and
outputting a list of executors of technical instructions which has been corrected on the basis of a current personnel situation and making changes in the IT system for these executors.

8. The method of claim 7, wherein executing the instruction further comprises the steps of:
inputting the list of the technical instructions execution of which is necessary for the change in access rights by the subordinated employee in the IT system;
inputting the list of executors of technical instructions which has been corrected on the basis of a current personnel situation and making changes in the IT system for these executors;
downloading the list of the enterprise employees possessing necessary duties for realization of actions on processing of the request;
identifying an access right by an IT-object to the resources which are supervised by the IT system; and
outputting modifications to the IT-object to change access rights to the IT system in accordance with received instructions.

9. The method of claim 8, wherein controlling the instruction execution process further comprises the steps of:
inputting the list of the technical instructions execution of which is necessary for the change in access rights by the subordinate employee in IT system;
identifying the access right by an IT-object to the resources which are supervised by the IT system;
using a program on the server that realizes the basic logic of the system security, carries out the interaction and improvement of the working system components and preserves the information from the data base; and
outputting information that is registered in the IT system of events on the change of access rights and IT-objects coherent with them, wherein realization of the change has taken place without development of technical instruction on the change.
